(19) United States
(12) Patent Application Publication
(10) Pub. No.: US 2011/0057646 A1
(43) Pub. Date: Mar. 10, 2011

(54) Apparatus and method for sensing position of non-orbital movable truck

(75) Inventors: Yosuke Takatori, Hitachi (JP); Yutaka Kometani, Hitachinaka (JP); Kenichi Otani, Hitachi (JP); Masafumi Imai, Hitachiota (JP); Ryoetsu Fujiwara, Mito (JP)

(73) Assignee: Hitachi-GE Nuclear Energy, Ltd.

(21) Appl. No.: 12/805,833

(22) Filed: Aug. 20, 2010

(30) Foreign Application Priority Data
Sep. 4, 2009 (JP) 2009-204254

(51) Int. Cl. G01B 7/14

(52) U.S. Cl. 324/207.24

(57) ABSTRACT

There is provided a position sensing apparatus when a non-orbital movable truck moves over a spherical surface, a cylindrical surface, or a flat surface, which is capable of position sensing even when, e.g., the non-orbital movable truck circumferentially moves over the spherical surface or the cylindrical surface to be hidden from the position sensing apparatus. A second linear encoder is disposed which includes a wire in a main body thereof to output an amount by which the wire is withdrawn as an encoder value. The tip of the wire of the second linear encoder is fixed to a position at the non-orbital movable truck to which the tip of the wire of a linear encoder is fixed. From an amount by which the wire of the linear encoder is withdrawn and the amount by which the wire of the second linear encoder is withdrawn, the position of the non-orbital movable truck is calculated in a calculation device.

### CLAIM OF PRIORITY

The present application claims priority from Japanese patent application serial No. 2009-204254 filed on Sep. 4, 2009, the content of which is hereby incorporated by reference into this application

### BACKGROUND OF THE INVENTION

1. Field of the Invention

The present invention relates to position sensing when a device used to perform inspecting, maintenance, repair, and like operations for a structural object or the like in a nuclear power plant or the like moves over a spherical surface, a cylindrical surface, or a flat surface of the structural object.

2. Description of the Related Art

As position sensing methods according to prior-art techniques, many methods have been used. The followings are the example of typical sensing methods.

(1) a method which uses transmitters for transmitting radio waves such as represented by GPS transmitters and a receiver mounted in a measurement target to sense a position of the target through reception of the radio waves transmitted from a plurality of the transmitters by the receiver or a method which uses ultrasonic waves instead of the radio waves using the same principle;
(2) a method which fixes a laser range finder at a known position, and irradiates a predetermined arbitrary position at a measurement target to measure the distance between the laser range finder and the measurement target;
(3) a method which photographs a measurement target with a plurality of cameras as represented by stereo cameras, and calculates a movement distance by image processing;
(4) a method which mounts an internal sensor such as, e.g., a trip meter, a gyroscopic sensor, an acceleration sensor, or a hydraulic head pressure sensor in a measurement target such that the position thereof is self-sensed.

In Japanese Unexamined Patent Publication No. 2006-170766, a flaw detector is described which has position sensing/processing means coupled to a probe for ultrasonic flaw detection or eddy current flaw detection to transmit the rotation of a ball to encoders via rollers, and determine the position of the probe described above.

In the above-mentioned method (1) using the principle of GPS, interference occurs between the radio waves from the individual transmitters under the influence of a surrounding structural object, and therefore the method cannot be used. For example, when the measurement target circumferentially moves over a spherical surface or a cylindrical surface, the measurement target having the receiver mounted therein moves away from the transmitters. When a non-orbital movable truck is located at a position across the diameter of a cylinder with respect to any of the transmitters, the radio wave transmitted from the transmitter should travel half around the entire cylindrical surface till it reaches the receiver so that the radio wave interference occurs.

In the above-mentioned method (2) using the laser range finder, when the measurement target circumferentially moves over a spherical surface or a cylindrical surface, the predetermined position at the measurement target cannot be irradiated with a laser because the laser has rectilinearity. There is also means for moving the position of the main body of the laser range finder so as to constantly irradiate the arbitrary position at the measurement target with the laser, but the position should be moved frequently. As described above, the work is unrealistic because of poor workability of a worker.

In the above-mentioned method (3) of measuring the movement distance by the image processing using the plurality of cameras also, when the measurement target circumferentially moves over the spherical surface or cylindrical surface, an image of the measurement target moves out of the angle of field of the cameras. Therefore, it is necessary to reset the positions of the cameras such that the measurement target enters the angle of field of the cameras so that the method is unrealistic similarly to the method using the laser range finder.

In the above-mentioned method (4) using the internal sensor, the trip meter may run idle or accuracy may deteriorate due to a cumulative error.

In view of the foregoing, an object of the present invention is to provide a position sensing apparatus when a non-orbital movable truck moves over a spherical surface, a cylindrical surface, or a flat surface, which is capable of position sensing even when, e.g., the non-orbital movable truck circumferentially moves over the spherical surface or the cylindrical surface to be hidden from the position sensing apparatus.

### SUMMARY OF THE INVENTION

To solve the problems described above, there is provided an apparatus for sensing a position of a non-orbital movable truck, including: a linear encoder including a wire in a main body thereof to output an amount by which the wire is withdrawn as an encoder value; a holding jig for holding the linear encoder; a non-orbital movable truck to which a connecting portion of the wire of the linear encoder is fixed; a calculation device for receiving the output of the linear encoder, and performing calculation; and a display unit for receiving and displaying an output of the calculation device.

With the arrangement, even when the non-orbital movable truck moves over a spherical surface, a cylindrical surface, or a flat surface, the effect of allowing position sensing can be obtained.

### BRIEF DESCRIPTION OF THE DRAWINGS

FIG. 1A is a sectional view of an apparatus for sensing a position of a non-orbital movable truck according to a first embodiment of the present invention;

FIG. 1B is a schematic view of an apparatus for sensing a position of a non-orbital movable truck according to a first embodiment of the present invention;

FIG. 2 is a schematic view illustrating a method for measuring an amount of movement of the non-orbital movable truck according to the first embodiment of the present invention;

FIG. 3 is a schematic view illustrating an error in measuring the amount of movement of the non-orbital movable truck according to the first embodiment of the present invention;

FIG. 4 is a flow chart of the procedure of the method for measuring the amount of movement of the non-orbital movable truck according to the first embodiment of the present invention;

FIG. 5 is a schematic view illustrating the procedure of the method for measuring the amount of movement of the non-orbital movable truck according to the first embodiment of the present invention;

FIG. 6 is a schematic view illustrating the procedure of the method for measuring the amount of movement of the non-orbital movable truck according to the first embodiment of the present invention;

FIG. 7 is a schematic view illustrating the procedure of the method for measuring the amount of movement of the non-orbital movable truck according to the first embodiment of the present invention;

FIG. 8 is a schematic view illustrating the procedure of the method for measuring the amount of movement of the non-orbital movable truck according to the first embodiment of the present invention;

FIG. 9 is a schematic view illustrating the procedure of the method for measuring the amount of movement of the non-orbital movable truck according to the first embodiment of the present invention;

FIG. 10A is a sectional view of an apparatus for sensing a position of a non-orbital movable truck according to a second embodiment of the present invention;

FIG. 10B is a schematic view of an apparatus for sensing a position of a non-orbital movable truck according to a second embodiment of the present invention; and

FIG. 11 is a schematic view illustrating a method for measuring an amount of movement of the non-orbital movable truck according to the second embodiment of the present invention.

### DETAILED DESCRIPTION OF THE PREFERRED EMBODIMENTS

Referring to the drawings, embodiments of the present invention will be shown below.

### Embodiment 1

An embodiment of an apparatus for sensing a position of a non-orbital movable truck according to the present invention will be described below with reference to the drawings.

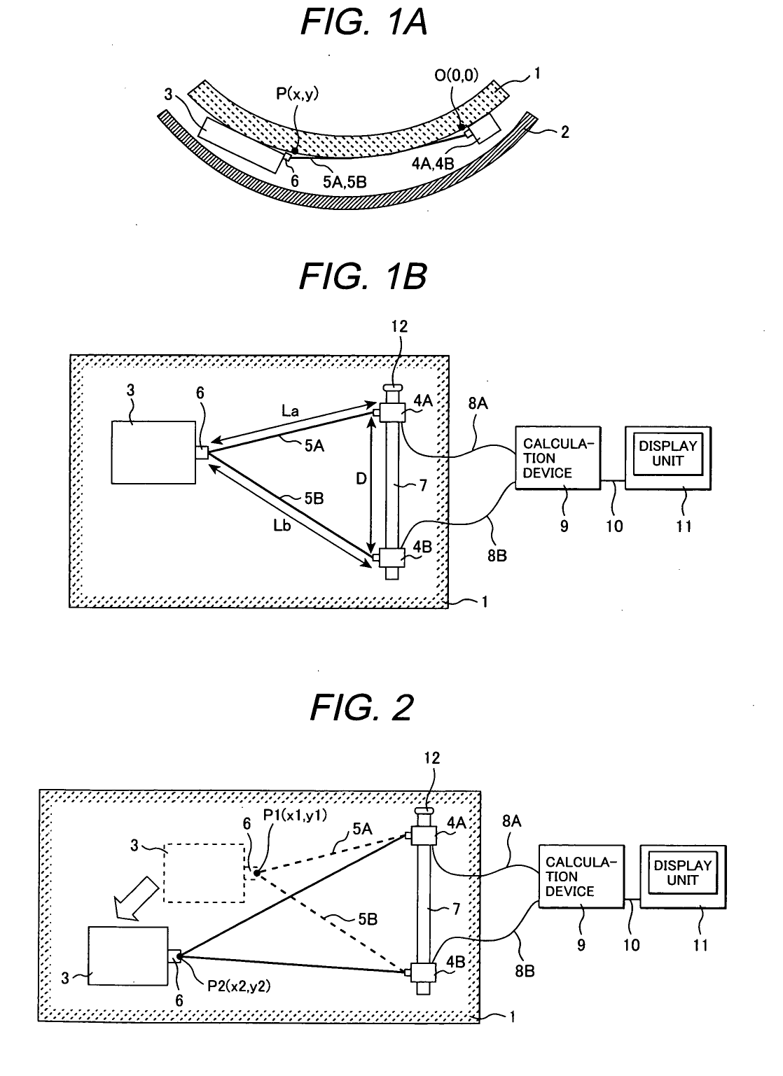

FIGS. 1A and 1B show the embodiment of the position sensing apparatus when the non-orbital movable truck circumferentially moves over the outer wall surface (cylindrical surface) of a nuclear reactor pressure vessel in a nuclear power plant to inspect the nuclear reactor pressure vessel as an example in which an environment where the non-orbital movable truck moves is narrow and confined by a surrounding structural object or the like, the workability of a worker is poor, and conventional position sensing methods cannot be used appropriately.

First, a structure thereof will be described using FIG. 1A. In a narrow space confined between a cylindrical nuclear reactor pressure vessel 1 and a similarly cylindrical heat insulating material 2 located outside the nuclear reactor pressure vessel 1 in the nuclear power plant, a non-orbital movable truck 3 which moves over the outer wall surface of the nuclear reactor pressure vessel 1 is mounted on the outer wall surface of the nuclear reactor pressure vessel 1. To a predetermined position at the non-orbital movable truck 3, a connecting portion 6 at each of the respective tips of wires 5A and 5B which are withdrawn from linear encoders 4A and 4B is fixed.

In FIG. 1B, the linear encoders 4A and 4B are mounted with a predetermined distance being maintained therebetween in a linear encoder holding jig 7 fixed to an arbitrary position at the nuclear reactor pressure vessel 1. Note that the linear encoder holding jig 7 is held while maintaining the given distance therebetween with a fixing rod. The linear encoder holding jig 7 is disposed using a level vial 12 such that an axis connecting the linear encoders 4A and 4B is vertical. Also, signal lines 8A and 8B for transmitting encoder signals from the linear encoders 4A and 4B are connected to the linear encoders 4A and 4B and to a calculation device 9 for the encoder signals, which is configured to display the result of calculation on a display unit 11 via a signal line 10.

A method for sensing a position of the non-orbital movable truck 3 in this structure will be described. It is assumed that respective amounts of withdrawal of the wires 5A and 5B are La and Lb, the distance between respective wire feed-out holes of the linear encoders 4A and 4B is D, a point obtained by projecting the wire feed-out hole of the linear encoder 4A in the radial direction of the nuclear reactor pressure vessel 1 is a point O(0,0), and a point obtained by projecting the connecting portion 6 in the radial direction of the nuclear reactor pressure vessel 1 is a point P(X,Y).

When the non-orbital movable truck 3 is at the position of FIGS. 1A and 1B, the wires are withdrawn from the linear encoders 4A and 4B by the respective amounts La and Lb, and encoder values corresponding to the amounts of withdrawal are transmitted to the calculation device 9 via the signal lines 8A and 8B. In the calculation device 9, a calculation program is installed in advance. The calculation device 9 calculates the coordinates of the point P(X,Y) obtained by projecting the connecting portion 6 fixed to the predetermined position at the non-orbital movable truck 3 in the radial direction of the nuclear reactor pressure vessel 1. The point P(X,Y) is given by Expressions (1) and (2) based on trigonometry.

$$\begin{matrix}( Expression 1 ) & \\ X = \frac{2 \sqrt{( α - La ) ( α - Lb ) ( α - D )}}{D} & ( 1 ) \\ ( Expression 2 ) & \\ y = \sqrt{{La}^{2} - {X}^{2}} wherein & ( 2 ) \\ ( Expression 3 ) & \\ α = \frac{La + Lb + D}{2} & ( 3 )\end{matrix}$$

is satisfied.

In addition, if the reference point of the nuclear reactor pressure vessel 1 is known, the point O(0,0) can be converted to a point O′(m,n) as the coordinate system of the nuclear reactor pressure vessel 1. That is, the coordinates of the point P(X,Y) can be converted to a point P′(X+m,Y+n) as the coordinate system of the nuclear reactor pressure vessel 1.

Moreover, by using the present position sensing system, when the non-orbital mobile truck 3 moves from a point P1 to a point P2 as shown in FIG. 2, an amount of movement ΔP, i.e., ΔX and ΔY can be calculated by calculating the points P1 and P2 according to Expressions (1) and (2), and obtaining the difference.

(Expression 4)

ΔP=P2−P1 (4)

(Expression 5)

ΔX=X2−X1 (5)

(Expression 6)

ΔY=Y2−Y1 (6)

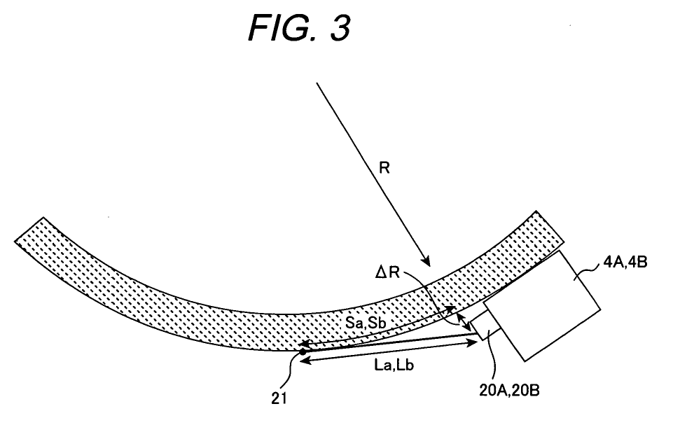

Note that, since the coordinates (X,Y) shown in Expressions (1) and (2) show coordinates in a coordinate system when two-dimensional X, Y coordinates are applied to the surface of the nuclear reactor pressure vessel 1, it follows that the feed-out holes 20A and 20B of the linear encoders 4A and 4B through which the wires 5A and 5B are fed are located at places each apart from the surface of the nuclear reactor pressure vessel 1 by a given distance ΔR, as shown in FIG. 3. That is, each of the wires 5A and 5B is linear till it reaches a contact point 21 with the nuclear reactor pressure vessel 1, and becomes conformal to the cylindrical surface after passing through the contact point 21.

As a result, differences are produced between distances Sa and Sb intended to be actually measured and the respective lengths La and Lb of the wires 5a and 5b to result in errors. However, by reducing the given distance ΔR to a value smaller than the radius R of the nuclear reactor pressure vessel 1, the differences between the distances Sa and Sb intended to be actually measured and the respective lengths La and Lb of the wires 5a and 5b can be substantially ignored.

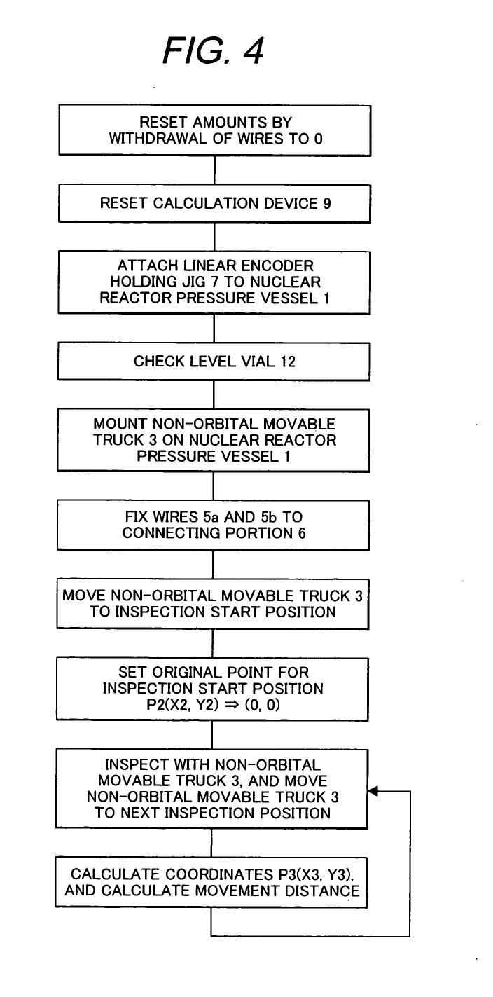

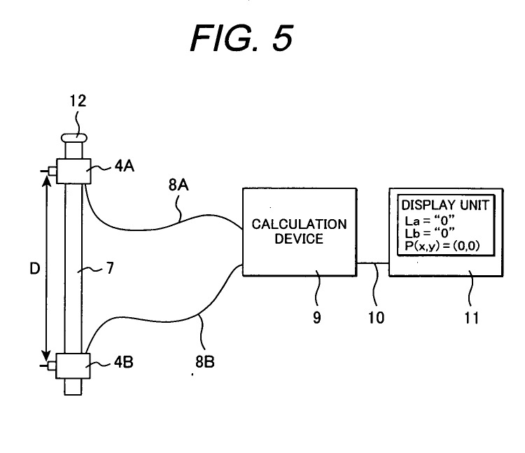

Next, the procedure of actually implementing the embodiment described heretofore will be described according to the work flow shown in FIG. 4 and FIG. 5 to FIG. 9. First, to inform the calculation device 9 of the state where the wires 5a and 5b of the linear encoders 4A and 4B are not withdrawn, i.e., the state where the amounts of withdrawal are “0” in the state shown in FIG. 5, the amounts of withdrawal of the wires 5a and 5b displayed on the display unit 11 in the state where the wires 5a and 5b are not withdrawn are reset to 0 as initial settings. At this time, the positional coordinates P0(X,Y) of the connecting portion 6 similarly displayed on the display unit 11 becomes (0,0).

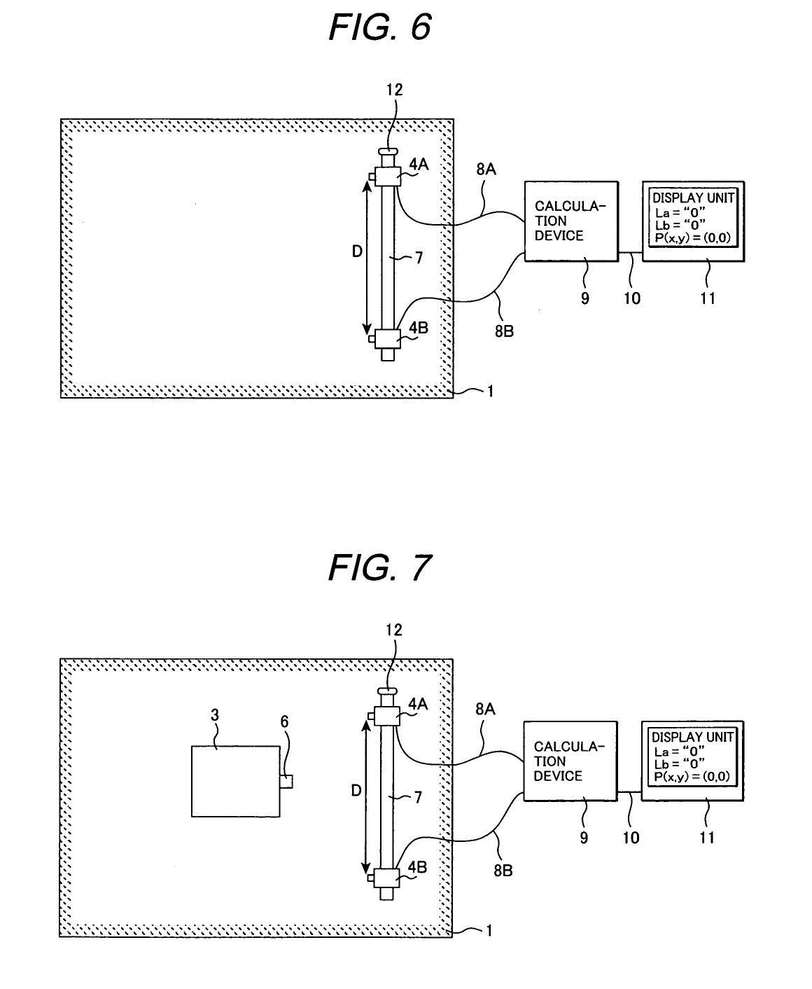

Next, as shown in FIG. 6, the linear encoder holding jig 7 is attached to the nuclear reactor pressure vessel 1 by means of a magnet or a suction cup. At this time, it is assumed that the linear encoder holding jig 7 is attached with care while checking the level vial 12 such that the longitudinal direction of the linear encoder holding jig 7 is vertical.

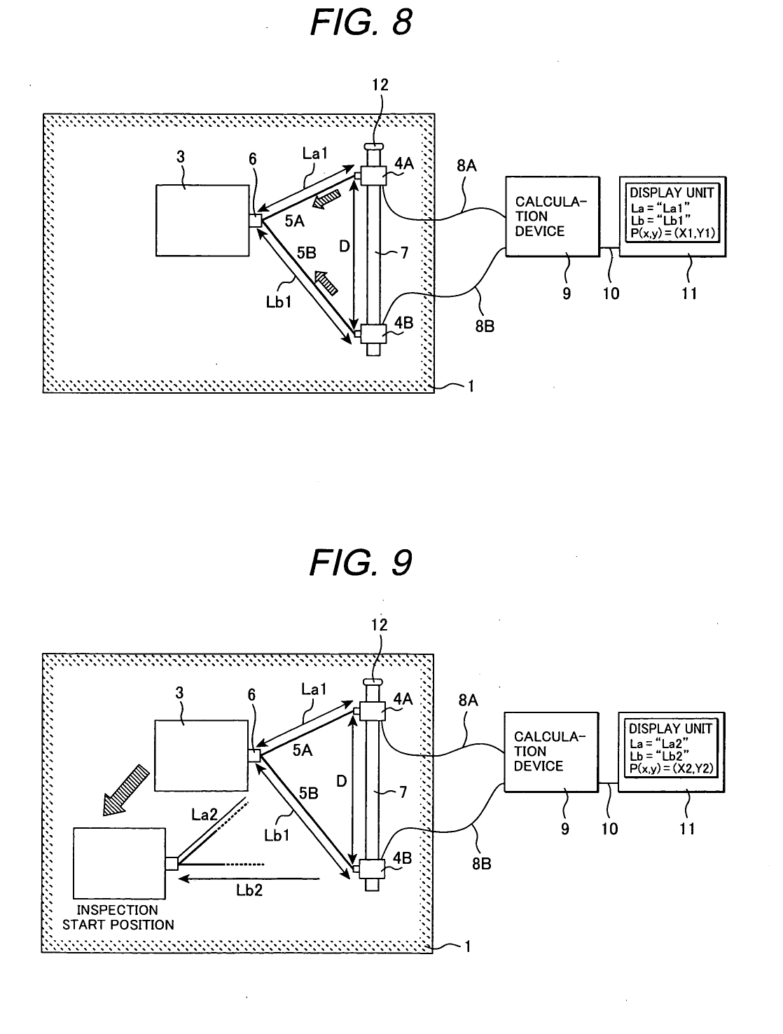

Next, as shown in FIG. 7, the non-orbital movable truck 3 is mounted on the nuclear reactor pressure vessel 1 and, as shown in FIG. 8, the wires 5a and 5b of the linear encoders 4A and 4B are pulled by a worker to be withdrawn, and fixed to the connecting portion 6 of the non-orbital movable truck 3. At this time, La1 and Lb1 shown in FIG. 8 are displayed in the respective amounts of withdrawal of the wires 5a and 5b displayed on the display unit 11, and the positional coordinates P1(X,Y) of the connecting portion 6 similarly displayed on the display unit 11 become (X1,Y1). However, since the non-orbital movable truck 3 is mounted at an arbitrary position, there is no particular problem.

Next, as shown in FIG. 9, the non-orbital movable truck 3 is moved to an inspection start position ( ). At this time, La2 and Lb2 shown in FIG. 9 are displayed in the amounts of withdrawal of the wires 5a and 5b displayed on the display unit 11, and the positional coordinates P2(X,Y) of the connecting portion 6 become (X2,Y2). However, since it is intended to set the inspection start position to the original point for the sake of convenience of an inspecting operation, the positional coordinates P2(X2,Y2) of the connecting portion 6 displayed on the display unit 11 are set to the original point(0,0). In this manner, the initial settings are completed.

Next, inspection using the non-orbital movable truck 3 is performed, and the non-orbital movable truck 3 is moved to the next inspection place. After the non-orbital movable truck 3 is moved, the amounts of withdrawal La2 and Lb2 of the wires 5a and 5b shift to La3 and Lb3, and the positional coordinates P2(X2,Y2) of the connecting portion 6 become P3(X3,Y3). At this time, ΔX and ΔY calculated from Expressions (5) and (6) are each displayed as the amount of movement of the non-orbital movable truck 3 on the display unit 11, and the worker can recognize the amount of movement of the non-orbital movable truck 3.

The structure described above allows the measurement of a relative position of the non-orbital movable truck from the arbitrary reference point to be easily performed when the environment where the non-orbital movable truck moves is narrow and confined by the surrounding structural object or the like, the workability of the worker is poor, and the conventional position sensing methods cannot be used appropriately.

### Embodiment 2

Next, a description will be given of a position sensing apparatus using one linear encoder as a second embodiment.

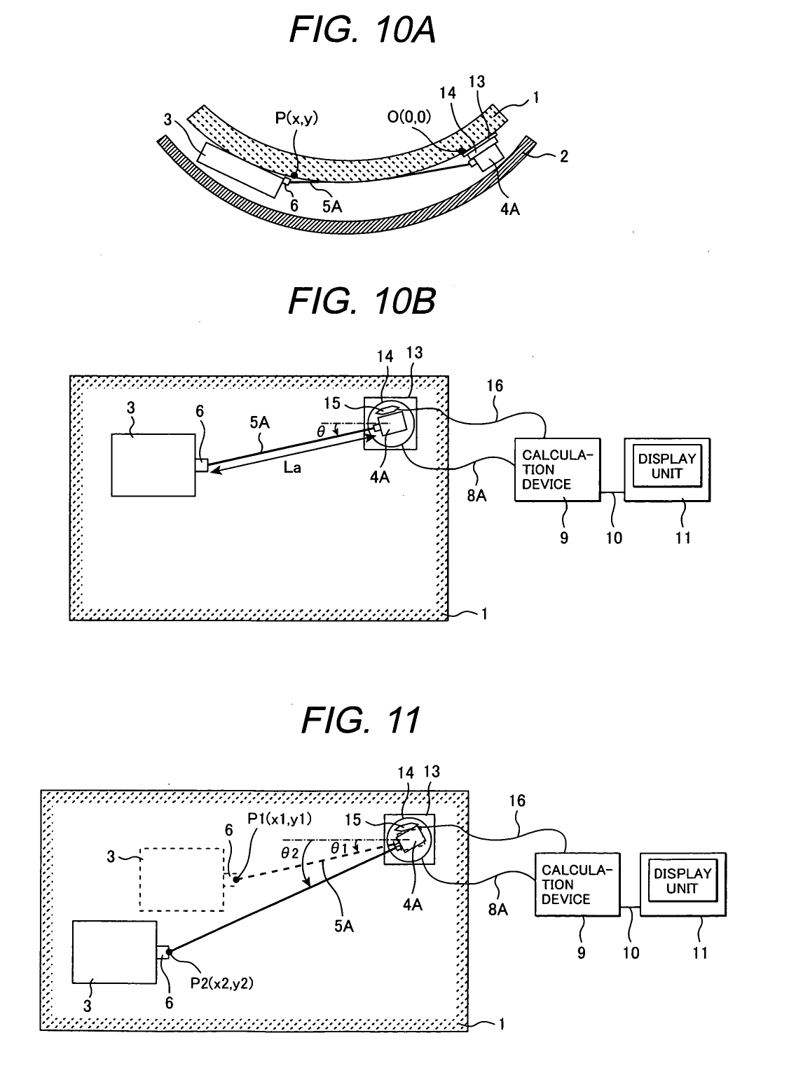

FIGS. 10A and 10B show the embodiment of the position sensing apparatus when a non-orbital movable truck circumferentially moves over the outer wall surface (cylindrical surface) of a nuclear reactor pressure vessel in a nuclear power plant as an example in which an environment where the non-orbital movable truck moves is narrow and confined by a surrounding structural object or the like, the workability of a worker is poor, and the conventional position sensing methods cannot be used appropriately, similarly to FIGS. 1A and 1B.

First, a structure thereof will be described. In a narrow space confined between the cylindrical nuclear reactor pressure vessel 1 and the similarly cylindrical heat insulating material 2 located outside the nuclear reactor pressure vessel in the nuclear power plant, the non-orbital movable truck 3 which moves over the outer wall surface of the nuclear reactor pressure vessel 1 is mounted on the outer wall surface of the nuclear reactor pressure vessel 1. To a predetermined position at the non-orbital movable truck 3, the connecting portion 6 at the tip of the wire 5A which is withdrawn from the linear encoder 4A is fixed. The linear encoder 4A is mounted in a linear encoder holding jig 13 with a rotation mechanism which is attached to the nuclear reactor pressure vessel 1.

To the linear encoder holding jig 13 with the rotation mechanism, a turn table 14 is attached as the rotation mechanism. To the turn table 14, a rotation angle detection sensor 15 is attached, and adjusted to output 0° in a horizontal position.

The signal line 8A for transmitting the encoder signal from the linear encoder 4A and a signal line 16 for transmitting an output value from the rotation angle detection sensor 15 are respectively connected from the linear encoder 4A and the rotation angle detection sensor 15 to the calculation device 9, which is configured to display the result of calculation on the display unit 11 via the signal line 10.

A method for sensing the position of the non-orbital movable truck 3 in this structure will be described. It is assumed that the amount of withdrawal of the wire 5A is La, an amount of rotation θ of the rotation angle detection sensor 15 is an output value, the point obtained by projecting the wire feed-out hole of the linear encoder 4A in the radial direction of the nuclear reactor pressure vessel 1 is the point O(0,0), and the point obtained by projecting the connecting portion 6 in the radial direction of the nuclear reactor pressure vessel 1 is the point P(X,Y).

When the non-orbital movable truck 3 is at the position of FIGS. 10A and 10B, the wire is withdrawn from the linear encoder 4A by the amount La, and the turn table rotates by the amount θ toward the connecting portion 6 of the non-orbital movable truck 3 at the same time as withdrawal. The encoder value corresponding to the amount of withdrawal La and the output value corresponding to the amount of rotation θ are transmitted to the calculation device 9 via the signal lines 8A and 16.

In the calculation device 9, a calculation program is installed in advance. The calculation device 9 calculates the coordinates of the point P(X,Y) obtained by projecting the connecting portion 6 fixed to the predetermined position at the non-orbital movable truck 3 in the radial direction of the nuclear reactor pressure vessel 1. The point P(X,Y) is given by Expressions (7) and (8) based on trigonometry.

(Expression 7)

X=La·sin θ (7)

(Expression 8)

y=La·cos θ (8)

In addition, if the reference point of the nuclear reactor pressure vessel 1 is known in the same manner as described above, the point O(0,0) can be converted to the point O′(m,n) as the coordinate system of the nuclear reactor pressure vessel 1. That is, the coordinates of the point P(X,Y) can be converted to the point P′ (X+m, Y+n) as the coordinate system of the nuclear reactor pressure vessel 1.

Moreover, by using the present position sensing system, when the non-orbital mobile truck 3 moves from the point P1 to the point P2 as shown in FIG. 11, the amount of movement ΔP can be calculated by calculating the points P1 and P2 according to Expressions (5) and (6), and obtaining the difference.

In the present embodiment, the measurement of the relative position of the non-orbital movable truck from the arbitrary reference point can be easily performed when the environment where the non-orbital movable truck moves is narrow and confined by the surrounding structural object or the like, the workability of the worker is poor, and the conventional position sensing methods cannot be used appropriately. Moreover, since position sensing is possible without using two linear encoders, the work can be performed by an easy operation and in a short period of time.

What is claimed is:

1. An apparatus for sensing a position of a non-orbital movable truck, comprising:
a linear encoder including a wire in a main body thereof to output an amount by which the wire is withdrawn as an encoder value;
a holding jig for holding the linear encoder;
a non-orbital movable truck to which a connecting portion of the wire of the linear encoder is fixed;
a calculation device for receiving the output of the linear encoder, and performing calculation; and
a display unit for receiving and displaying an output of the calculation device.

2. The apparatus for sensing a position of a non-orbital movable truck according to claim 1, further comprising:
a second linear encoder including a wire in a main body thereof to output an amount by which the wire is withdrawn as an encoder value and holded on the holding jig;
the non-orbital movable truck to which a connecting portion of the wire of the second linear encoder is fixed; and
the calculation device for retrieving the output of the linear encoder and the output of the second linear encoder, and performing calculation with the retrieved outputs.

3. The apparatus for sensing a position of a non-orbital movable truck according to claim 2, wherein the linear encoder and the second linear encoder are positioned such that an axis connecting the linear encoder and the second linear encoder is vertical or horizontal.

4. The apparatus for sensing a position of a non-orbital movable truck according to claim 2, wherein the holding jig and the non-orbital movable truck are disposed outside a nuclear reactor pressure vessel.

5. The apparatus for sensing a position of a non-orbital movable truck according to claim 1, wherein the linear encoder has:
angle sensing means for sensing an angle at which the wire is withdrawn; and
the calculation device for receiving the angle outputted from the angle sensing means and the output of the linear encoder, and performing calculation.

6. The apparatus for sensing a position of a non-orbital movable truck according to claim 5, wherein the holding jig and the non-orbital movable truck are disposed outside the nuclear reactor pressure vessel.

7. A method for sensing a position of a non-orbital movable truck, comprising:
disposing a holding jig to which a linear encoder including a wire in a main body thereof to output an amount by which the wire is withdrawn as an encoder value is fixed;
fixing a tip of the wire of the linear encoder to an arbitrary position at the non-orbital movable truck; and
calculating a position of the non-orbital movable truck from the amount by which the wire of the linear encoder is withdrawn in a calculation device.

8. The method for sensing a position of a non-orbital movable truck according to claim 7, further comprising:
disposing a second linear encoder including a wire in a main body thereof to output an amount by which the wire is withdrawn as an encoder value is fixed on the holding jig;
fixing a tip of the wire of the second linear encoder to the position at the non-orbital movable truck to which the tip of the wire of the linear encoder is fixed; and
calculating the position of the non-orbital movable truck from the amount by which the wire of the linear encoder is withdrawn and from the amount by which the wire of the second linear encoder is withdrawn in the calculation device.

9. The method for sensing a position of a non-orbital movable truck according to claim 8, wherein the linear encoder and the second linear encoder are positioned such that an axis connecting the linear encoder and the second linear encoder is vertical or horizontal.

10. The method for sensing a position of a non-orbital movable truck according to claim 9, wherein the holding jig, and the non-orbital movable truck are disposed outside a nuclear reactor pressure vessel.

11. The method for sensing a position of a non-orbital movable truck according to claim 7, wherein the linear encoder receives an angle outputted from angle sensing means for sensing the angle at which the wire is withdrawn and the output of the linear encoder, and calculation is performed with the angle and the output in the calculation device.

12. The method for sensing a position of a non-orbital movable truck according to claim 11, wherein the holding jig and the non-orbital movable truck are disposed outside a nuclear reactor pressure vessel.
